(19) United States
(12) Patent Application Publication
(10) Pub. No.: US 2002/0117923 A1
(43) Pub. Date: Aug. 29, 2002

(54) Permanent magnet embedded motor, rotor for motor and method for manufacturing motor and rotor

(76) Inventor: Hiromitsu Takei, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/036,090

(22) Filed: Nov. 6, 2001

(30) Foreign Application Priority Data
Nov. 10, 2000 (JP) 2000-343722

(51) Int. Cl. H02K 21/12

(52) U.S. Cl. 310/156.11

(57) ABSTRACT

A permanent magnet embedded motor is equipped with a rotor including a rotor core made of magnetic material and having a plurality of slits formed at corresponding poles, and bond magnets embedded in the slits. Each of the bond magnets is a pre-formed plate-shaped bond magnet, prepared independently of the rotor core. The bond magnets can be magnetized before they are fitted in the slits. At least one of the length dimension and the width dimension of each of the bond magnets in a cross-section orthogonal to an axis of the rotor is larger than the corresponding dimension of the corresponding one of the slits, and the bond magnets are pressure-inserted in the slits.

### BACKGROUND OF THE INVENTION

1. Field of the Invention

The present invention relates to a permanent magnet embedded motor in which permanent magnets are embedded in a rotor, a rotor for the motor and methods for manufacturing the motor and rotor.

2. Description of Related Art

When using sintered-type permanent magnets in a permanent magnet embedded motor, a slit 30 is formed at each pole of a rotor core 3 that is formed from a layer of stacked magnetic material plates such as silicon steel plates. A permanent magnet 4′ is embedded in each of the slits 30, as shown in FIG. 13(A). Here, each permanent magnet 4′ has a fitting margin for the corresponding slit 30 such that the permanent magnet 4′ may be slightly smaller than the corresponding slit 30.

FIG. 14A schematically shows a process flow chart for manufacturing such a rotor 2′. Initially, a rotor core 3 with slits, a shaft 20 and sintered-type permanent magnets 4′ are independently prepared. In a press fitting step ST 11, the shaft 20 is press fitted into the rotor core 3. Next, in an assembly step ST 12, the permanent magnets 4′ are embedded in slits 30 of the rotor core 3. In the event of defects such as the permanent magnet 4′ protruding from the rotor core slits, the permanent magnet 4′ is ground in an additional magnet grinding step ST 13. Next, after fixing the permanent magnets 4′ in the slits 30 with adhesive in the adhesion step ST 14, the permanent magnets 4′ are magnetized in an external magnetizing step ST 15.

In the rotor 2′ thus comprised, the magnetic flux density falls at places where gaps between each slit 30 and the corresponding permanent magnet 4′ are greater due to dimensional errors in the permanent magnet 4′ or the slit 30. Further, a reinforcing fixing step ST 16, in which the permanent magnets are fixed in the slits using adhesives or bolts, may sometimes be carried out as part of the adhesion step ST 14, when there are gaps between the slit 30 and the corresponding permanent magnet 4′. However, this method entails the problem of deviations in the position of the various permanent magnets 4′ within their corresponding slits 30. Moreover, when sintered-type permanent magnets 4′ have, for example, an arc-shape shown in FIG. 13(B) so as to be embedded in arc-shaped slits of a rotor core 3 shown in FIG. 13(B), it is quite difficult to manufacture permanent magnets 4′ having such a shape using the sintered method with high precision relative to the slits 30 shown in FIG. 13(B). Accordingly, a substantially large fitting margin needs to be provided.

In one technique that copes with the problems described above, bond magnet fluid is directly poured into the slits 30 of the rotor core 3, and the bond magnet fluid is solidified in the slits 30, whereby the bond magnets in are embedded in the slits 30 of the rotor core 3. According to such technique, the permanent magnets (bond magnets) can be embedded without any gaps regardless of the shape of the slit 30 of the rotor core 3.

However, in the method in which the bond magnet fluid is directly poured into the slits 30 of the rotor core 3 described above, the direction in which the fluid is filled is restricted to one direction (i.e., the punching direction of the rotor core), which does not yield sufficient properties. Further, as the number of poles increases, the number of time-consuming filling process increases, which reduces productivity and causes deviations in the magnetic properties among bond magnets due to deviations in filling. Moreover, due to the fact that the bond magnets must be magnetized after they are embedded in the slits 30, there are problems of requiring a magnetizer compatible with the shape of the rotor core 3 and of significantly complicated magnetizing conditions.

### SUMMARY OF THE INVENTION

In view of the problems stated above, an object of the present invention is to provide a permanent magnet embedded motor, a rotor for the motor and a method for manufacturing such motor and rotor, in which there are no deviations in magnetic properties and in which a rotor can be easily manufactured even when bond magnets are used as permanent magnets.

In accordance with one embodiment of the present invention, a permanent magnet embedded motor comprises a rotor including a rotor core made of magnetic material and having a plurality of slits formed at corresponding poles, and at least one bond magnet embedded in at least one of the slits, wherein the at least one bond magnet is formed from a plate-shaped bond magnet, wherein at least one of the length dimension and the width dimension of a cross-section of the at least one bond magnet orthogonal to an axis of the rotor is larger than the corresponding dimension of the at least one of the slits, and the at least one bond magnet is fitted in the at least one of the slits under pressure. It is noted that a permanent magnet embedded motor may also be referred to as a motor with embedded permanent magnets.

The present invention takes advantage of the property of bond magnet of being approximately 5% compressible in order to press fit slightly oversized bond magnets into the slits of the rotor core to thereby embed the bond magnets into the slits of the rotor core. Accordingly, unlike the method in which bond magnet fluid is directly poured into and solidified in slits, the embodiment of the present invention does not need to carry out the time-consuming filling step. As a result, the production efficiency does not fall even with a greater number of magnetic poles. Additionally, there are no deviations in the magnetic properties caused by deviations in filling with the fluid. Furthermore, due to the fact that the bond magnets can be magnetized while still in a plate shape, preferably in a flat plate shape, before they are embedded in the slits, only one magnetizer that can magnetize plate-shaped bond magnets is needed, regardless of the type of rotor being manufactured. Moreover, with magnetization performed on plate-shaped bond magnets, magnetizing is easy and can be carried out under stable conditions. As a result, according to the present embodiments, there are no deviations in magnetic properties and the rotor can be manufactured easily even when bond magnets are used as permanent magnets. In addition, because bond magnets are deformable they can be press-fitted into slits of various shapes.

In the present invention, the bond magnets may have a structure in which both the length dimension and the width dimension are larger than those of the slits, and the opening section of the slits has an arc shape, a V shape or a channel shape with any appropriate cross section such as a U-shaped cross section, a flattened U-shaped cross section or the like.

In the present invention, the slits may have a structure in which the width dimension is partially narrow. Further, the slits may have a structure in which the width dimension changes in the length direction. With such a structure, when a plate-shaped bond magnet having a constant width dimension in the length direction is press fitted into a slit, the bond magnet is compressed to a greater degree in places where the width of the slit is narrow and therefore is in contact with the inner surface of the slit with a greater force, which consequently makes it highly unlikely for the bond magnet to slip out of the slit.

In the present invention, the bond magnet has a plate shape that is formed by rolling or compression press machining, which is conducted before they are fitted into the slits.

In a method for manufacturing a permanent magnet embedded motor in accordance with one embodiment of the present invention, when fitting a bond magnet into a corresponding slit of a rotor core, a gate member having at least one tapered pathway with an exit opening smaller than an opening section of the slit is placed against the rotor core, the bond magnet is pressed into the tapered pathway continuous with the slit, and the bond magnet is pushed into the slit while being deformed. With the method described above, the bond magnet can be readily and effectively press-fitted into the slit of the rotor core.

In the method for manufacturing a permanent magnet embedded motor in accordance with one aspect of the present invention, each bond magnet is magnetized before it is fitted into the corresponding slit, such that the magnetized bond magnets are press-fitted into the slits of the rotor core. With such a structure, the bond magnets can be magnetized readily and under stable conditions.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 shows a plan view of a structure of a permanent magnet embedded motor to which the present invention has been applied.

FIG. 2 shows a plan view of a rotor used in the motor in accordance with an embodiment 1 of the present invention.

FIG. 3 shows an illustration to describe the embedded structure of a bond magnet used in a rotor shown in FIG. 2.

FIGS. 4(A), 4(B) and 4(C) are illustrations to describe the dimensional relations between bond magnets and slits used in the rotor in FIG. 2.

FIG. 5 shows a process chart for assembling the rotor in FIG. 2 in a method for manufacturing a motor in accordance with one embodiment of the present invention.

FIG. 6 shows an illustration to describe how to press fit bond magnets into slits of a rotor core in manufacturing the rotor in FIG. 2.

FIG. 7 shows a plan view of a rotor in accordance with an embodiment 2 of the present invention.

FIG. 8 shows a plan view of a rotor in accordance with an embodiment 3 of the present invention.

FIG. 9 shows a plan view of a rotor in accordance with an embodiment 4 of the present invention.

FIG. 10 shows a plan view of a rotor in accordance with an embodiment 5 of the present invention.

FIG. 11 shows a plan view of a rotor in accordance with an embodiment 6 of the present invention.

FIG. 12 shows a plan view of a rotor in accordance with an embodiment 7 of the present invention.

FIGS. 13(A) and 13(B) show plan views of rotors used in motors with embedded permanent magnets.

FIG. 14 shows a process chart for assembling an embedded permanent magnet-type rotor using sintered-type permanent magnets.

### EMBODIMENTS OF THE INVENTION

A permanent magnet embedded motor to which the present invention is applied will be described with references to the accompanying drawings.

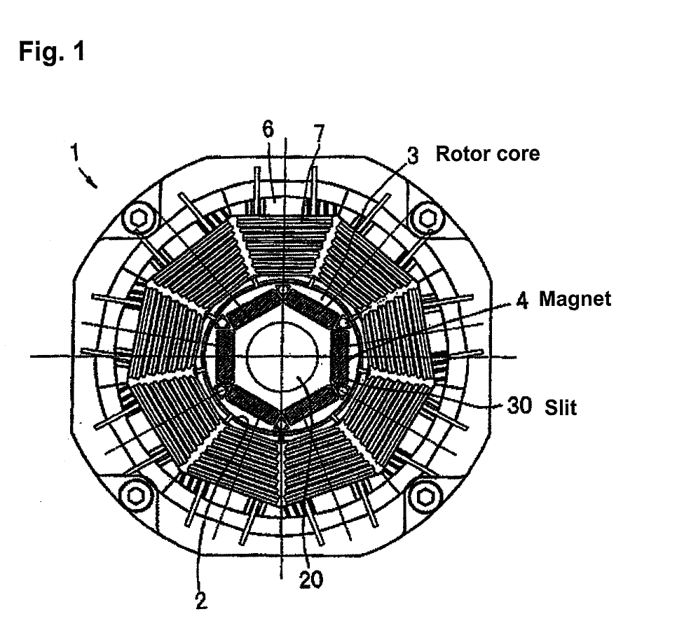

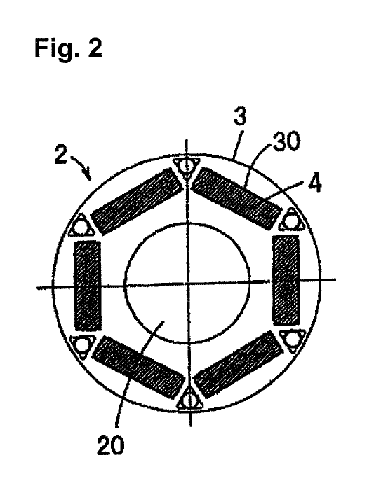

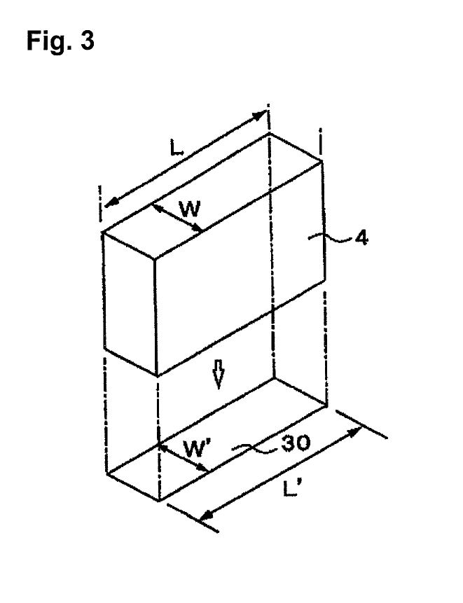

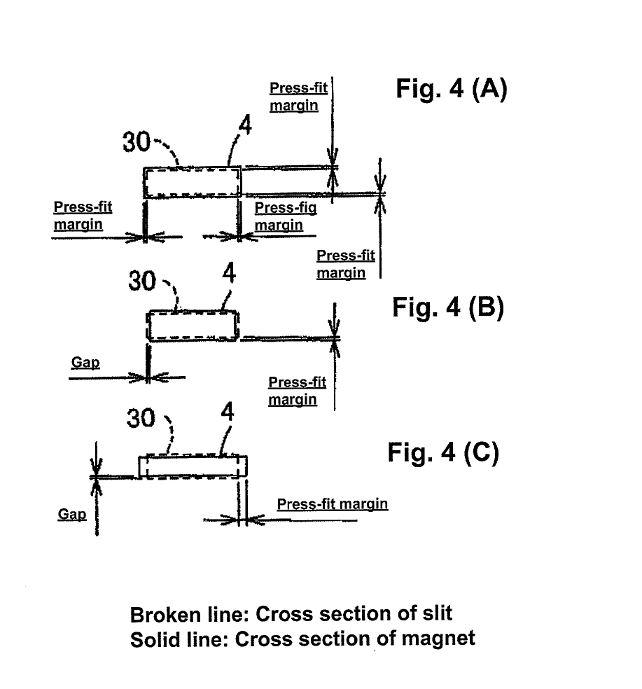

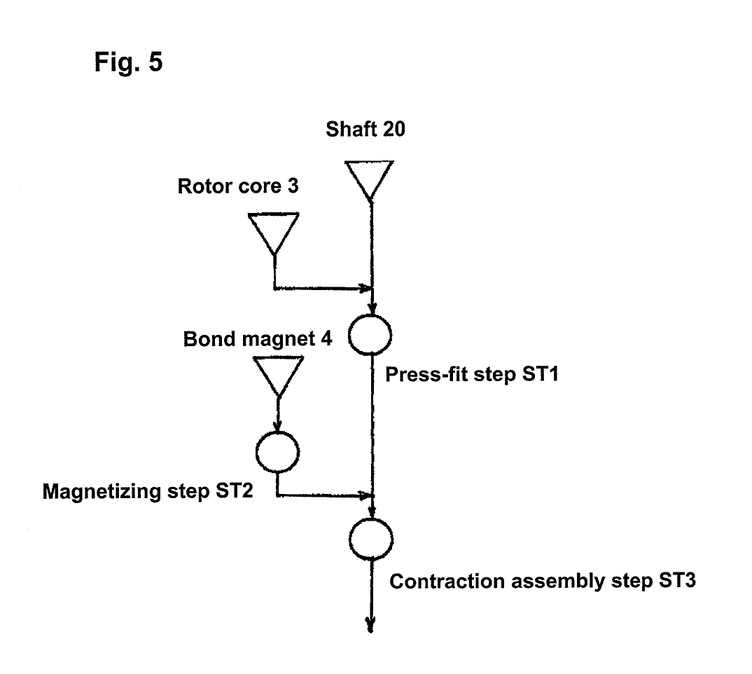

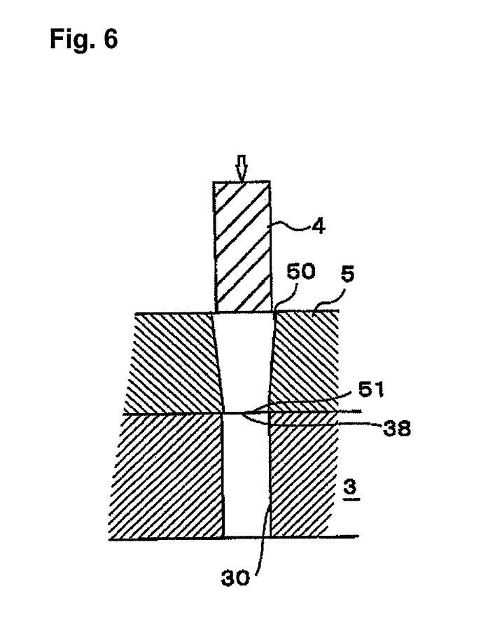

FIG. 1 is a plan view showing a structure of a permanent magnet embedded motor (hereinafter called a “motor”) in accordance with an embodiment 1 of the present invention. FIG. 2 is a plan view of a rotor used in the motor of the embodiment of the present invention. FIG. 3 is an illustration to describe the embedded structure of bond magnets used in the rotor in FIG. 2. Each of FIGS. 4(A), 4(B) and 4(C) is an illustration to describe the dimensional relations between a bond magnet and a slit used in the rotor in FIG. 2. FIG. 5 is a process chart for the assembly process of the rotor in FIG. 2 in accordance with a method for manufacturing a motor in accordance with one embodiment of the present invention. FIG. 6 is an illustration to describe how a bond magnet is press fitted into a slit of a rotor core in the manufacture of the rotor in FIG. 2.

A permanent magnet embedded motor 1 shown in FIG. 1 comprises a rotor 2 having a circular, flat shape, and a stator 6 placed in a manner to encircle the rotor 2. The motor 1 in this example has six poles, and a plurality of permanent magnets that are formed from bond magnets 4 are embedded in the rotor 2, one at each of the magnetic poles. In addition, the stator 6 has nine salient poles projecting towards the rotor 2, and a coil 7 is wound around each of the salient poles.

As shown in FIG. 2, the rotor 2 includes a rotor core 3 formed from a layer of a plurality of stacked steel plates, and a shaft 20 (that defines a rotation center axis) fixed generally at the center of the rotor core 3. Six slits 30 are provided in the rotor core 3 at equiangular interval about the shaft 20, and the bond magnet 4 are embedded in the respective slits 30. The bond magnets 4 are formed from magnetic powder dispersed in a resin material used as a binder and are elastically deformable by approximately 5% under normal circumstances.

In one embodiment, at least one of the bond magnets 4 is pre-formed into a plate-shape with a constant width dimension W (thickness) formed through rolling or compression press machining. The bond magnets 4 are magnetized in their flat plate shape before they are press-fitted into the slits 30. Then, the pre-formed bond magnets 4 are embedded in the slits 30, as shown in FIG. 3. Since the bond magnets 4 are magnetized in their flat plate shape before they are press-fitted into the slits 30, the magnetized bond magnets 4 are press-fitted into the slits 30 of the rotor core 3.

In another embodiment, a bond magnet in a plate shape may be pre-formed and then cut into segments each having an appropriate size that fits in each of the slits 30.

In the rotor 2, each of the bond magnets 4 may preferably be in a plate shape, in which at least one of the length dimension L and the width dimension W of the plate shape is larger than the corresponding length dimension L′ or the width dimension W′ of the slit 30, such that the bond magnets 4 are press-fitted into the respective slits 30. It is noted that the length dimension L and the width dimension W of the slit are dimensions defined in a cross-section of the slit orthogonal to the axis of the shaft 20 (rotation center axis).

For example, as shown in FIG. 4(A), the bond magnet 4 has a length dimension and a width dimension that are both greater than those of the slit 30. As a result, press-fit margins are secured between the bond magnet 4 and the slit 30 in both the length direction and the width direction.

In another embodiment, as shown in FIG. 4(B), of the length dimension and the width dimension of the bond magnet 4, the width dimension is greater than that of the slit 30 and the length dimension is smaller than that of the slit 30. As a result, a press-fit margin is secured only in the width direction between the bond magnet 4 and the slit 30, so that when the bond magnet 4 is press fitted into the slit 30, there would be gaps between the bond magnet 4 and the slit 30 in the length direction.

In still another embodiment, as shown in FIG. 4(C), of the length dimension and the width dimension of the bond magnet 4, the length dimension is greater than that of the slit 30 and the width dimension is smaller than that of the slit 30. As a result, a press-fit margin is secured only in the length direction between the bond magnet 4 and the slit 30, so that when the bond magnet 4 is press fitted into the slit 30, there would be gaps between the bond magnet 4 and the slit 30 in the width direction.

To manufacture the permanent magnet embedded motor 1 having the structure described above, the rotor core 3 with slits, the shaft 20 and the bond magnets 4 are prepared independently, and then the shaft 20 is press fitted into the rotor core 3 in a press fit step ST 1, as shown in FIG. 5.

Next, after magnetizing the plate-shaped bond magnets 4 in a magnetizing step ST 2, the bond magnets 4 are press fitted into the slits 30 of the rotor core 3 while being compressed in a predetermined direction in a contraction assembly step ST 3. When performing the contraction assembly step ST 3, a gate member 5 may be used. The gate member 5 is provided with a tapered pathway 50 with an exit opening 51 smaller than an opening section 38 of each of the slits 30. In the contraction assembly step ST 3, the gate member 5 is placed against the rotor core 3, the bond magnet 4 is pushed into the tapered pathway 50 continuous with the corresponding slit 30, and the bond magnet 4 is pushed into the slit 30 while being deformed. Although not shown, the gate member 5 may be provided with a plurality of tapered pathways, and a plurality of bond magnets may be fitted in a corresponding plurality of the slits at the same time. As a result, the rotor 2 with the bond magnets 4 embedded in the slits 30 is completed.

If there are gaps between the slits 30 and the bond magnets 4, adhesive is filled into the gaps as necessary.

In the rotor 2 thus manufactured, by taking advantage of the property of the bond magnet 4 of being approximately 5% compressible, the slightly oversized bond magnets 4 are press fitted into the slits 30 of the rotor core 3.

The bond magnet 4 is flexibly deformable in its length direction and width direction by approximately 5%. Accordingly, the length or the width of the slit 30 may be made slightly smaller than the length or the width of the bond magnet 4 such that, when the bond magnet 4 is fitted in the slit 30, the bond magnet 4 is flexibly contracted in the slit 30, and exerts a compression force against an internal wall of the slit 30. Accordingly, unlike the method in which bond magnet fluid is directly poured into and solidified in slits, there is no need to carry out the time-consuming filling step in the embodiment of the present invention. As a result, the production efficiency does not fall even with a greater number of magnetic poles. Additionally, there are no deviations in the magnetic properties caused by deviations in filling the slits with the fluid, according to the present embodiment. Furthermore, due to the fact that the bond magnets 4 can be magnetized while still in a plate shape before they are embedded in the slits 30, only one magnetizer that can magnetize flat plate-shaped bond magnets 4 is needed, regardless of the type of the rotor 2 being manufactured. Moreover, with magnetization performed on plate-shaped bond magnets 4, magnetizing is easy and can be carried out under stable conditions. As a result, according to the present embodiment, there are no deviations in magnetic properties and the rotor 2 can be manufactured readily even when bond magnets 4 are used as permanent magnets.

Furthermore, in the present embodiment, due to the fact that the bond magnets 4 are press fitted into the slits 30 while being deformed by using the gate member 5 with the exit opening 51 smaller than the opening section 38 of the slits 30, the bond magnets 4 can be press fitted into the slits 30 of the rotor core 3 readily and efficiently.

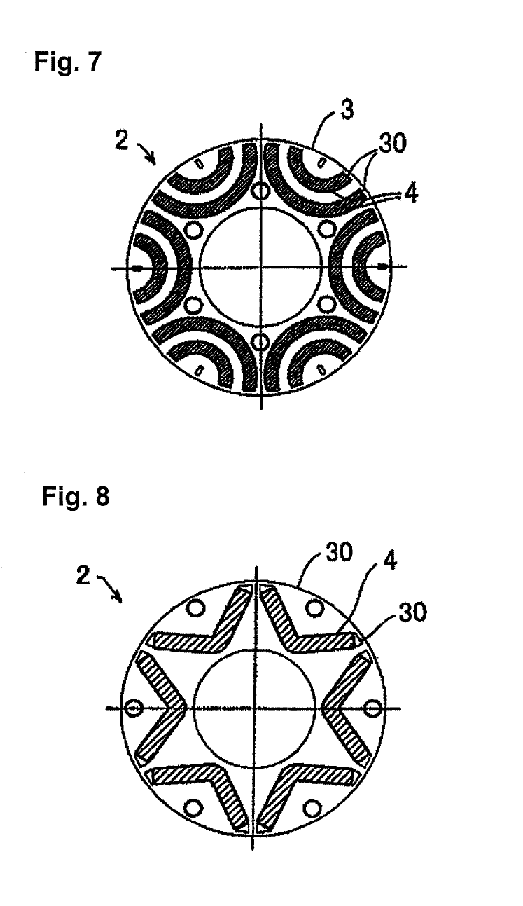

FIG. 7 is a plan view of a rotor 2 in accordance with an embodiment 2 of the present invention. This embodiment and each of the subsequent embodiments all share the basic structure described in the above embodiment, and only the shape of slits 30 of a rotor core 3 and the shape of bond magnets 4 are different. Accordingly, in the following descriptions, same components are assigned the same numbers and description of their manufacturing methods is omitted.

As shown in FIG. 7, the rotor 2 in the present embodiment also has a rotor core 3 made of magnetic material and a bond magnet 4 embedded in each slit 30 formed at each pole of the rotor core 3. Two sets of the bond magnets 4 and the slits 30, both in an arc shape, are provided at each pole.

In the rotor 2, each of the bond magnets 4 is in a plate shape, in which at least one of the length dimension along the curve of the arc and the width dimension of the bond magnet 4 is greater than the corresponding dimension of the slit 30. The bond magnets 4 are press-fitted into the slits 30. For example, of the length dimension and the width dimension of the bond magnet 4, the width dimension is greater than that of the slit 30 and the length dimension is smaller than that of the slit 30. As a result, when the bond magnets 4 are press-fitted into the corresponding slits 30, gaps may form in the length direction between the edges of each of the bond magnets 4 and the edges of the corresponding slit 30. These gaps may be formed as a countermeasure for demagnetization, and adhesive may be filled into the gap as necessary.

In the rotor 2 thus structured, due to the fact that the slightly oversized bond magnets 4 are press fitted into the slits 30 of the rotor core 3 and that the bond magnets 4 are thereby embedded in the slits 30 of the rotor core 3, effects similar to those gained in the above embodiment can be obtained, such as doing away with the time-consuming process of filling bond magnet fluid into the slits 30. In addition, with the bond magnets 4, it is easy to bend their flat plate shape into an arc shape, which makes it easy to embed the bond magnets 4 in the arc-shaped slits 30, as in the present embodiment. Furthermore, even when embedding the bond magnets 4 in such a shape, there is an added advantage of being able to magnetize the bond magnets 4 while they are in a flat plate shape before embedding them in the slits 30.

FIG. 8 is a plan view of a rotor 2 in accordance with an embodiment 3 of the present invention.

As shown in FIG. 8, the rotor 2 in the present embodiment also has a rotor core 3 made of magnetic material and a bond magnet 4 embedded in each slit 30 formed at each pole of the rotor core 3, in which both the bond magnets 4 and the slits 30 are in a V shape. In the rotor 2, each of the bond magnets 4 is in a plate shape that bends in a V shape, in which at least one of the length dimension along the V-shape and the width dimension is greater than the corresponding dimension of the corresponding slit 30. The bond magnets 4 are press-fitted into the slits 30. For example, of the length dimension and the width dimension of the bond magnets 4, the width dimension is greater than that of the slits 30 and the length dimension is smaller than that of the slits 30. As a result, when the bond magnets 4 are press fitted into the slits 30, gaps form in the length direction between the edges of each of the bond magnets 4 and the edges of the corresponding slit 30. These gaps may be formed as a countermeasure for demagnetization, and adhesive may be filled into the gap as necessary.

In the rotor 2 thus structured, due to the fact that the slightly oversized bond magnets 4 are press fitted into the slits 30 of the rotor core 3 and that the bond magnets 4 are thereby embedded in the slits 30 of the rotor core 3, effects similar to those gained in the embodiment 1 described above can be obtained, such as, for example, the necessity of time-consuming process of filling bond magnet fluid into the slits 30 can be eliminated. In addition, with the bond magnets 4, it is easy to bend their flat plate shape into a V shape, which makes it easy to position the bond magnets in a V shape, as in the present embodiment. Furthermore, even with such a shape, there is an added advantage of being able to magnetize the bond magnets 4 while they are in a flat plate shape before embedding them in the slits 30.

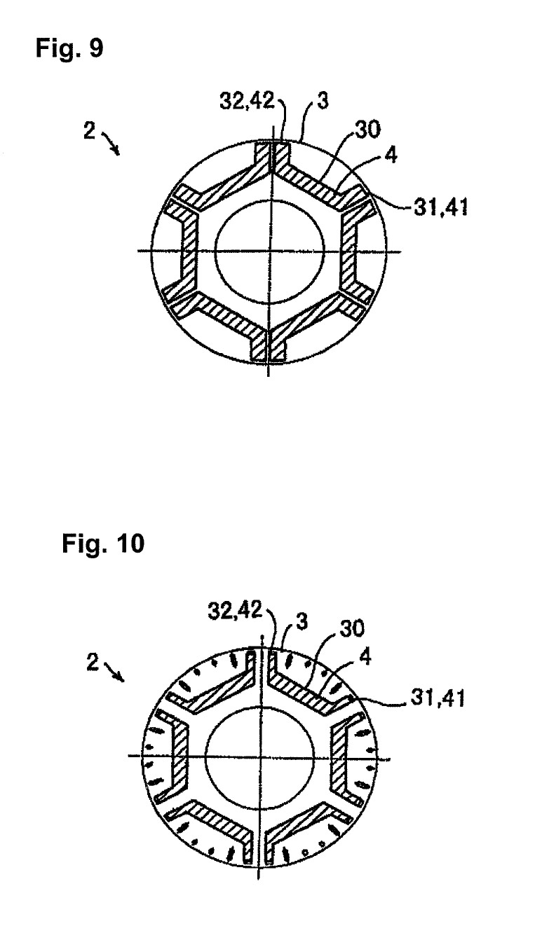

FIG. 9 is a plan view of a rotor 2 in accordance with an embodiment 4 of the present invention.

As shown in FIG. 9, the rotor 2 in the present embodiment also has a rotor core 3 made of magnetic material and a bond magnet 4 embedded in each slit 30 formed at each pole of the rotor core 3; both the slits 30 and the bond magnets 4 are in a channel shape with their end sections 31, 32 and 41, 42, respectively, facing outward. Here, the rotor 2 has the bond magnets 4 in a plate shape, in which at least one of the length dimension or the width dimension is larger than the corresponding dimension of the slits 30, and the bond magnets 4 are press fitted into the slits 30. For example, both the length dimension and the width dimension of each of the bond magnets 4 may be made greater than those of the slit 30 such that there are no gaps between each of the bond magnets 4 and the corresponding slit 30.

In the rotor 2 thus structured, due to the fact that the slightly oversized bond magnets 4 are press fitted into the slits 30 of the rotor core 3 and that the bond magnets 4 are thereby embedded in the slits 30 of the rotor core 3, effects similar to those gained in the embodiment 1 can be obtained, for example, the necessity of time-consuming process of filling bond magnet fluid into the slits 30 can be eliminated. In addition, with the bond magnets 4 in a flat shape, it is easy to bend their flat plate shape into a channel shape, which makes it easy to position the bond magnets 4 in a channel shape, as in the present embodiment. Furthermore, even with such a shape, there is an added advantage of being able to magnetize the bond magnets 4 while they are in a flat plate shape before embedding them in the slits 30.

FIG. 10 is a plan view of a rotor 2 in accordance with an embodiment 5 of the present invention.

As shown in FIG. 10, the rotor 2 in the present embodiment also has a rotor core 3 made of magnetic material and a bond magnet 4 embedded in each slit 30 formed at each pole of the rotor core 3. Both the bond magnet 4 and the slit 30 are in a channel shape with end sections 31 and 32 facing outward. In the present embodiment, the end sections 31 and 32 of each of the slits 30 are narrower than its central section, and end sections 41 and 42 of each of the bond magnets 4 are correspondingly narrower.

With the rotor 2 thus structured, the bond magnets 4 in a plate shape, in which at least one of the length dimension and the width dimension is greater than the corresponding dimension of the slits 30, are press fitted into the slits 30. For example, of the length dimension and the width dimension of the bond magnets 4, the width dimension may be larger than that of the slits 30 and the length dimension may be smaller than that of the slits 30. As a result, when the bond magnets 4 are press-fitted into the slits 30, gaps may form in the length direction between the edges of each bond magnet 4 and the edges of the corresponding slit 30. These gaps may be filled with adhesive as necessary. Each of the bond magnets 4 may be in a flat plate shape with a uniform thickness (i.e., a uniform width) before they are inserted in the corresponding slits 30. Due to the narrow end sections 31 and 32 of the slits 3, the end sections 41 and 42 of the bond magnets 4 are compressed to a greater degree than their central sections in order to be embedded in the slits 30.

In the rotor 2 thus structured, due to the fact that the slightly oversized bond magnets 4 are press fitted into the slits 30 of the rotor core 3 and that the bond magnets 4 are thereby embedded in the slits 30 of the rotor core 3, effects similar to those gained in embodiment 1 can be obtained, for example, the necessity of the time-consuming process of filling bond magnet fluid into the slits 30 can be eliminated. In addition, the bond magnets 4 in a straight plate shape can be readily bent into a channel shape, which makes it easy to position the bond magnets 4 in a channel shape, as in the present embodiment. Furthermore, even with such a shape, there is an added advantage of being able to magnetize the bond magnets 4 while they are in a flat plate shape before embedding them in the slits 30.

In addition, the end sections 31 and 32 of the slits 30 have a narrow width, and the end sections 41 and 42 of the bond magnets 4 are also correspondingly narrow. Consequently, the bond magnets 4 are in contact with the inner surface of the slits 30 with greater force commensurate to the greater degree the end sections 41 and 42 are compressed, which eliminates the risk of the bond magnets 4 slipping out of the slits 30.

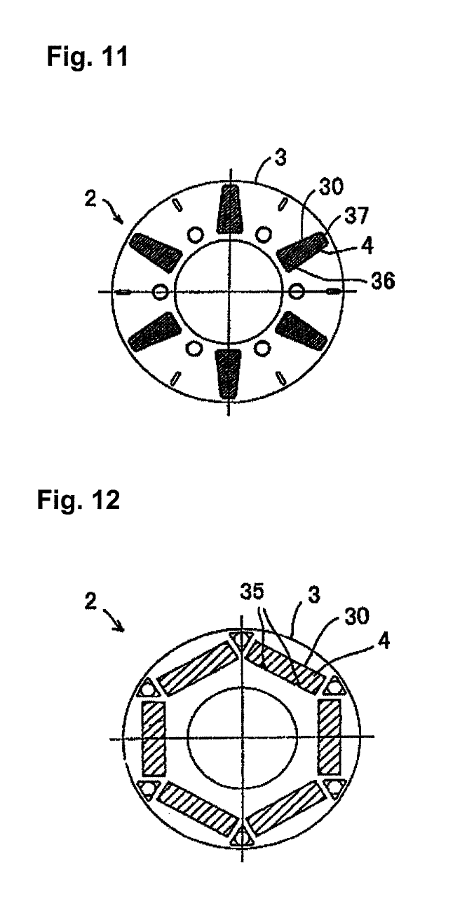

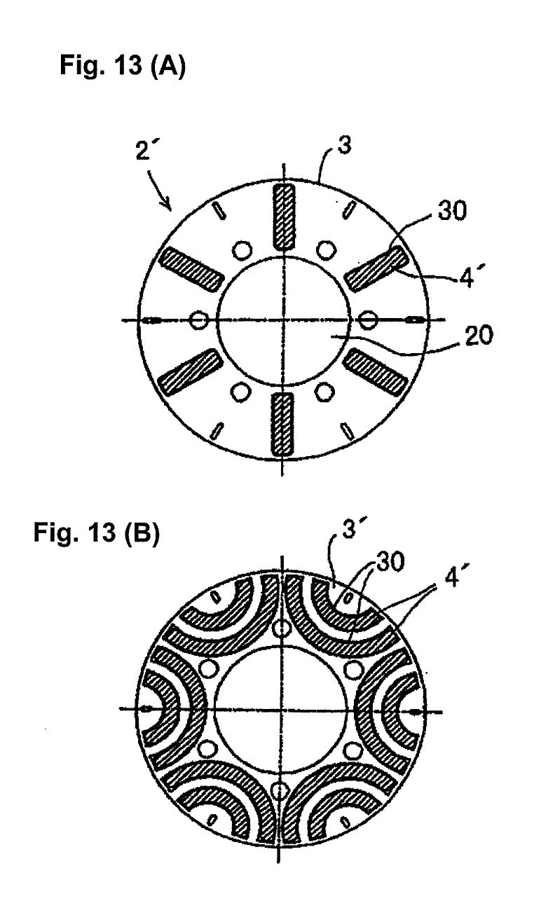

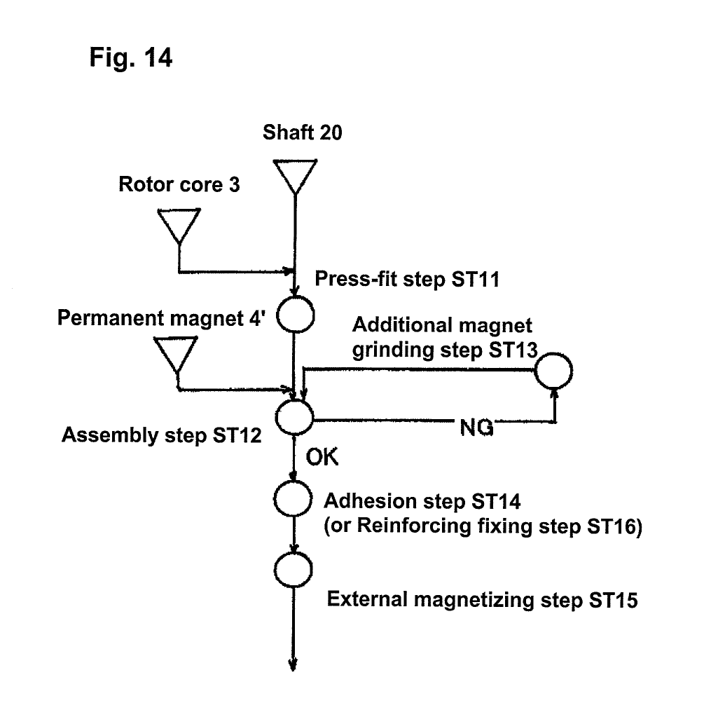

FIG. 11 is a plan view of a rotor 2 in accordance with an embodiment 6 of the present invention.

As shown in FIG. 11, the rotor 2 in the present embodiment also has a rotor core 3 made of magnetic material and a bond magnet 4 embedded in each slit 30 formed at each pole of the rotor core 3, wherein both the bond magnets 4 and the slits 30 are radially positioned. More specifically, each of the slits 30 has a generally rectangular shape with its longer sides extending radially with respect to the axis of the rotor shaft.

In this embodiment, the width of each slit 30 narrows progressively from an inner circumference side 36 towards an outer circumference side 37 (i.e., in the length direction), and the width dimension of an outer circumference side 47 of each bond magnet 4 is correspondingly narrow.

With the rotor 2 thus structured, the bond magnets 4 in a plate shape, in which at least one of the length dimension or the width dimension is larger than the corresponding dimension of the slits 30, are press fitted into the slits 30. For example, both the length dimension and the width dimension of the bond magnets 4 may be greater than those of the slits 30. As a result, when the bond magnets 4 are press-fitted into the slits 30, there are no gaps between each bond magnet 4 and the corresponding slit 30. The bond magnets 4 are embedded in the slits 30 in a manner in which the bond magnets 4 are progressively compressed to a greater degree towards the outer circumference side 37.

In the rotor 2 thus structured, due to the fact that the slightly oversized bond magnets 4 are press fitted into the slits 30 of the rotor core 3 and that the bond magnets 4 are thereby embedded in the slit 30 of the rotor core 3, effects similar to those gained in embodiment 1 can be obtained, for example, the necessity of the time-consuming process of filling bond magnet fluid into the slits 30 can be eliminated. In addition, although the width of the slit 30 narrows towards the outer circumference side 37 to define a wedge-shape, the bond magnet 4 having a flat plate shape with a constant width can be press-fitted into the slit 30 having such a wedge-shape. This can be done by progressively compressing the bond magnets 4 to a greater degree towards the outer circumference side 37.

Furthermore, due to the fact that the bond magnets 4 are compressed to a greater degree in areas where the width of the slits 30 is narrow, the bond magnets 4 are in contact with the inner surface of the slits 30 with greater force, which eliminates the risk of the bond magnets 4 slipping out of the slits 30. Moreover, even when embedding the bond magnets 4 in the slits 30 of this shape, there is an added advantage of being able to magnetize the bond magnets 4 while they are in a flat plate shape before embedding them in the slits 30.

FIG. 12 is a plan view of a rotor 2 in accordance with an embodiment 7 of the present invention.

As shown in FIG. 12, the rotor 2 in the present embodiment also has a rotor core 3 made of magnetic material and a bond magnet 4 embedded in each slit 30 formed at each pole of the rotor core 3.

With the rotor 2 thus structured, the bond magnets 4 in a plate shape, in which at least one of the length dimension and the width dimension is larger than the corresponding dimension of the slits 30, are press fitted into the slits 30. For example, both the length dimension and the width dimension of the bond magnets 4 may be larger than those of the slits 30. As a result, when the bond magnets 4 are press-fitted into the slits 30, there are no gaps between each bond magnet 4 and the corresponding slit 30.

In this embodiment, a plurality of small protrusions 35 are formed on the inner surface of the slit 30, and the small protrusions 35 bite into the bond magnets 4 press fitted into the slits 30.

In the rotor 2 thus structured, due to the fact that the slightly oversized bond magnets 4 are press fitted into the slits 30 of the rotor core 3 and that the bond magnets 4 are thereby embedded in the slit 30 of the rotor core 3, effects similar to those gained in embodiment 1 can be obtained, such as doing away with the time-consuming process of filling bond magnet fluid into the slits 30. In addition, due to the fact that the small protrusions 35 bite into the bond magnets 4, the risk of the bond magnets 4 slipping out of the slits 30 is eliminated.

As explained above, a motor with embedded permanent magnets and its manufacturing method according to the present invention take advantage of the property of the bond magnet, which is approximately 5% compressible, in order to press fit slightly oversized bond magnets into the slits of the rotor core and embed the bond magnets into the slits of the rotor core. Accordingly, unlike the conventional method in which the bond magnet fluid is directly poured into and solidified in slits, there is no need to carry out the time-consuming filling step in the present invention. As a result, the production efficiency does not fall even with a greater number of magnetic poles. Additionally, there are no deviations in the magnetic properties caused by deviations in filling with the fluid. Furthermore, due to the fact that the bond magnets can be magnetized while still in a flat plate shape before they are embedded in the slits, only one magnetizer that can magnetize flat plate-shaped bond magnets is needed. As a result, according to the present embodiments, there are no deviations in magnetic properties and the rotor can be manufactured easily even when bond magnets are used as permanent magnets. In addition, because bond magnets are deformable they can be press-fitted into slits of various shapes.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotor for a permanent magnet embedded motor, the rotor comprising:
a rotor core made of magnetic material and having a plurality of slits formed at corresponding poles; and
at least one bond magnet embedded in at least one of the slits,
wherein the at least one bond magnet is formed from a plate-shaped bond magnet, wherein at least one of a length dimension and a width dimension of the at least one bond magnet in a cross-section orthogonal to an axis of the rotor is greater than a corresponding dimension of the at least one of the slits, and the at least one bond magnet is fitted in the at least one of the slits under pressure.

2. A rotor according to claim 1, wherein the at least one bond magnet has a length dimension and a width dimension that are both greater than those of the at least one of the slit.

3. A rotor according to claim 1, wherein each of the slits has an opening section in one of an arc shape, a V shape and a channel shape.

4. A rotor according to claim 1, wherein at least one of the slits has a partially narrow section in the width dimension thereof.

5. A rotor according to claim 1, wherein the width dimension of the at least one of the slits changes in a length direction thereof.

6. A rotor according to claim 1, wherein each of the slits comprises a plurality of protrusions formed on an inner surface thereof to extend into a corresponding bond magnet fitted in the slit.

7. A rotor according to claim 1, wherein the at least one bond magnet is flexibly compressive and flexibly contracted in the corresponding slit.

8. A rotor according to claim 1, wherein the at least one bond magnet is flexibly compressive in at least one of a length direction and a width direction thereof and flexibly contracted in the corresponding slit in at least one of the length direction and the width direction.

9. A rotor according to claim 1, wherein at least one of the length dimension and the width dimension of the at least one bond magnet is approximately 5% larger than the corresponding dimension of the at least one of the slits.

10. A method for manufacturing a rotor for a permanent magnet embedded motor, the rotor comprising a rotor core made of magnetic material and having a plurality of slits formed at corresponding poles of the rotor core, the method comprising the steps of:
preparing at least one plate-shaped bond magnet, wherein at least one of a length dimension and a width dimension of the bond magnet in a cross-section orthogonal to a shaft of the rotor is greater than a corresponding dimension of a corresponding one of the slits;
placing against the rotor core a gate member having a tapered pathway with an exit opening smaller than an opening section of one of the slits; and
pressing in the bond magnet into the tapered pathway continuous with the slit, and pushing the bond magnet into the one of the slits while deforming the bond magnet.

11. A method for manufacturing a rotor according to claim 10, wherein the at least one plate-shaped magnet comprises a plurality of plate-shaped magnets, and the plurality of plate-shaped magnets are inserted in the corresponding respective slits under pressure.

12. A method for manufacturing a rotor according to claim 10, wherein the one of the slits that has a partially narrow section and the at least one plate-shaped magnet is inserted under pressure in the one of the slits to cause a greater compression force in the least one plate-shaped magnet at an area thereof that is in contact with the partially narrow section in the one of the slits than compression forces working in the at least one plate-shaped magnet that is in contact with areas other than the partially narrow section.

13. A method for manufacturing a rotor for a permanent magnet embedded motor, the rotor comprising a rotor core made of magnetic material and having a plurality of slits formed at corresponding poles of the rotor core, the method comprising the steps of:
preparing plate-shaped bond magnets, in which at least one of the length dimension or width dimension of each of the bond magnets in a cross-section thereof orthogonal to a shaft of the rotor is greater than a corresponding dimension of each corresponding one of the slits;
magnetizing the bond magnets before the bond magnets are inserted in the slits; and
press-fitting the bond magnets that are magnetized into the slits of the rotor core.

14. A method for manufacturing a rotor according to claim 13, wherein each of the bond magnets prepared is in a flat plate-shape, which is magnetized and subsequently press fitted into each corresponding one of the slits of the rotor core.

15. A method for manufacturing a rotor according to claim 13, wherein each of the bond magnets is formed in a plate shape through rolling.

16. A method for manufacturing a rotor according to claim 13, wherein each of the bond magnets is formed in a plate shape through compression press machining.

17. A method for manufacturing a rotor according to claim 13, wherein the each of the bond magnets is flexibly compressible and flexibly contracted in the corresponding slit.

18. A method for manufacturing a rotor according to claim 13, wherein each of the bond magnets is flexibly compressive in at least one of a length direction and a width direction thereof and flexibly contracted in the corresponding slit in at least one of the length direction and the width direction.

19. A method for manufacturing a rotor according to claim 13, wherein at least one of the length dimension and the width dimension of each of the bond magnets is approximately 5% larger than the corresponding dimension of corresponding one of the slits.

20. A permanent magnet embedded motor comprising:
a rotor including a rotor core made of magnetic material and having a plurality of slits formed at corresponding poles and bond magnets embedded in the corresponding slits slits,
wherein each of the bond magnets is formed from a plate-shaped bond magnet, wherein at least one of a length dimension and a width dimension of each of the bond magnets in a cross-section orthogonal to an axis of the rotor is greater than a corresponding dimension of the corresponding one of the slits, and the bond magnets are fitted in the corresponding slits under pressure.
